(19) United States
(12) Patent Application Publication
(10) Pub. No.: US 2012/0273220 A1
(43) Pub. Date: Nov. 1, 2012

(54) PRESSURE RELIEF VALVE

(75) Inventors: Mark Ezekiel, Magnolia, TX (US); Wyatt Chase Breidenthal, Houston, TX (US)

(73) Assignee: BP CORPORATION NORTH AMERICA INC., Houston, TX (US)

(21) Appl. No.: 13/453,322

(22) Filed: Apr. 23, 2012

Related U.S. Application Data
(60) Provisional application No. 61/479,693, filed on Apr. 27, 2011.

(51) Int. Cl. F16K 17/04; E21B 34/04

(52) U.S. Cl. 166/360; 137/542

(57) ABSTRACT

A pressure relief valve for use submerged in a body of water includes a first seal element in a water-filled chamber having an outlet into the body of water. In addition, the pressure relief valve comprises a spring in a water-filled chamber biasing the first seal element into sealing engagement with a second seal element and forming a seal until the pressure opposing the seal equals or exceeds a predetermined pressure.

### CROSS-REFERENCE TO RELATED APPLICATIONS

This application claims the benefit of U.S. Provisional Application No. 61/479,693 filed Apr. 27, 2011, incorporated herein by reference.

### STATEMENT REGARDING FEDERALLY SPONSORED RESEARCH OR DEVELOPMENT

Not applicable.

### BACKGROUND

In producing oil and gas from offshore wells, a wellhead is employed at the seafloor and the hydrocarbons flow from the wellhead through tubular risers to the surface where the fluids are collected in a receiving facility located on a platform or other vessel. Normally, the flow of hydrocarbons is controlled via a series of valves installed on the wellhead, the risers, and in the receiving facility at the surface. At times, temporary flow lines from the wellhead to a receiving facility may be installed. In all such instances, it is important to prevent excessive pressure from building up in these lines. Such pressures could build up due to hydrate formation, sudden changes in pressure in the well bore, or back pressure from valve closings or from other processes. Pressures could cause equipment failures at the sea floor, which may be 5,000-7,000 feet or more below the surface. At those depths, the water pressure exceeds 2000 p.s.i. Because of the depth and pressures, effectuating repairs can require that equipment and tools be handled by deep diving, using, for example, remotely operated vehicles (ROV's) which are essentially robots controlled by an operator in a surface vessel. Controlling the vehicles from such distances and using the ROV's to repair and/or replace equipment and components is a difficult and time consuming task.

### BRIEF SUMMARY OF THE DISCLOSURE

Accordingly, a device is required to limit pressures in the subsea flow lines and other hydrocarbon-containing equipment to non-destructive levels, and to relieve excess pressure when required. Any pressure relief device installed at the sea bed must be capable of reliable operation at the extreme pressures that are encountered, and withstand the highly-corrosive environment of the ocean.

These and other needs in the art are addressed in one embodiment by a pressure relief valve for use submerged in a body of water. In an embodiment, the pressure relief valve includes a first seal element in a water-filled chamber having an outlet into the body of water. In addition, the pressure relief valve includes a spring in a water-filled chamber biasing the first seal element into sealing engagement with a second seal element and forming a seal until the pressure opposing the seal equals or exceeds a predetermined pressure.

These and other needs in the art are addressed in another embodiment by a pressure relief valve for protecting against overpressure conditions in a volume of hydrocarbons contained subsea. In an embodiment, the pressure relief valve includes a base portion having a base chamber, and a nozzle extending into the base chamber and in fluid communication with the volume of contained hydrocarbons. The base chamber has an outlet open to the surrounding sea water for porting into the sea hydrocarbons that enter the base chamber through the nozzle. In addition, the pressure relief valve includes a bonnet portion coupled to the base portion and having a bonnet chamber in fluid communication with the base chamber and in fluid communication with the sea. Further, the pressure relive valve includes a disk disposed in the base chamber and adapted to sealingly engage the nozzle and prevent the contained hydrocarbons from entering the base chamber when the fluid pressure of the contained hydrocarbons is less than a predetermined pressure, and to disengage from sealing engagement with the nozzle when the fluid pressure of the contained hydrocarbons equals or exceeds the predetermined pressure. Still further, the pressure relief valve includes a spring housed in the bonnet chamber adapted to supply a force to bias the disk to sealingly engage the nozzle when the fluid pressure of the contained hydrocarbons is less than the predetermined pressure.

These and other needs in the art are addressed in another embodiment by a subsea system for containing a volume of hydrocarbons. In an embodiment, the system includes a subsea container having hydrocarbons retained therein. In addition, the system includes a pressure relief valve coupled to the subsea container and adapted to relieve pressure in the container if the pressure reaches a predetermined value. The relief valve includes a plurality of chambers that are flooded with seawater. Further, the relief valve includes a metal to metal seal in one of the flooded chambers. Still further, the relief valve includes a spring member in one of the flooded chambers adapted to bias a first seal member into sealing engagement with a second seal member when the hydrocarbon pressure in the container is less than the predetermined pressure. The relief valve also includes an outlet to port into the sea hydrocarbons that enter the valve when the hydrocarbon pressure in the container is greater than or equal to the predetermined pressure.

Thus, embodiments described herein comprise a combination of features and advantages intended to address various shortcomings associated with certain prior devices, systems, and methods. The various characteristics described above, as well as other features, will be readily apparent to those skilled in the art upon reading the following detailed description, and by referring to the accompanying drawings.

### BRIEF DESCRIPTION OF THE DRAWINGS

For a detailed description of the disclosed embodiments of the invention, reference will now be made to the accompanying drawings in which:

FIG. 1 is a schematic view of an embodiment of a subsea hydrocarbon recovery system including a subsea pressure relief valve made in accordance with principles described herein.

FIG. 2 is an elevation view, partly in cross section, of the pressure relief valve of FIG. 1.

### DETAILED DESCRIPTION OF DISCLOSED EMBODIMENTS

A pressure relief valve for underwater applications is disclosed herein. The valve can be employed in many underwater applications; however, it has particular application as a device to relieve overpressures that may develop in subsea flow lines, manifolds, tanks and vessels containing and/or transporting hydrocarbons from the sea floor. For convenience, the word “container” may be used herein to refer to all such hydrocarbon-containing lines, manifolds, tanks and vessels.

The following description is exemplary of embodiments of the invention, but these embodiments are not to be interpreted or otherwise used as limiting the scope of the disclosure, including the claims. One skilled in the art will understand that the following description has broad application, and the discussion of any embodiment is meant only to be exemplary of that embodiment, and is not intended to suggest in any way that the scope of the disclosure, including the claims, is limited to that embodiment.

The drawing figures are not necessarily to scale. Certain features and components disclosed herein may be shown exaggerated in scale or in somewhat schematic form, and some details of conventional elements may not be shown in the interest of clarity and conciseness.

The terms “including” and “comprising” are used herein, including in the claims, in an open-ended fashion, and thus should be interpreted to mean “including, but not limited to . . . .” Also, the term “couple” or “couples” is intended to mean either an indirect or direct connection. Thus, if a first component couples or is coupled to a second component, the connection between the components may be through a direct engagement of the two components, or through an indirect connection that is accomplished via other intermediate components, devices and/or connections.

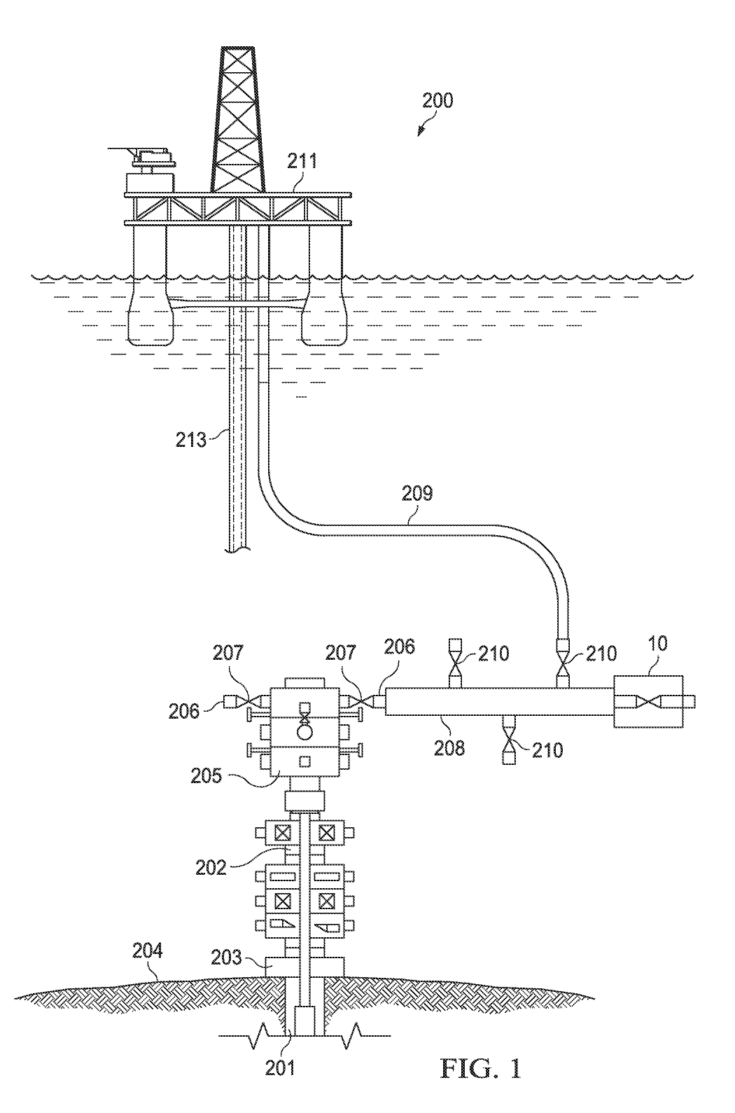

Referring to FIG. 1, an exemplary embodiment of an offshore system 200 for recovering hydrocarbons from a subsea wellbore 201 is shown. In this embodiment, system 200 includes a blowout preventer (BOP) 202 mounted to a wellhead 203 at the sea floor 204, and a capping stack 205 mounted atop BOP 202. In a typical system for producing from well 201, hydrocarbons are allowed to flow through the BOP 202, through a lower marine riser package (not shown), and through risers 213 to a hydrocarbon-receiving vessel at the surface, such as platform 211. In this example, however, capping stack 205 has been substituted for a lower marine riser package in a situation, for example, where hydrocarbon flow is not controlled via the normal path and is instead diverted and collected via an alternate collection system.

Capping stack 205 includes at least one fluid outlet 206 controlled by a valve 207 for controlling the flow of hydrocarbons from the well to various destinations, including into a distribution manifold 208. In turn, one or more flowlines 209 are connected to valved outlets 210 in the manifold 208 and are employed to transport the hydrocarbons from the well to one or more hydrocarbon storage vessels at the surface, such as platform 211. A pressure relief valve 10 is coupled to subsea manifold 208 and is in fluid communication with hydrocarbons contained in manifold 208. When valved outlet 210 interconnecting flowline 209 and manifold 208 is open, pressure relief valve 10 is likewise in fluid communication with flow line 209.

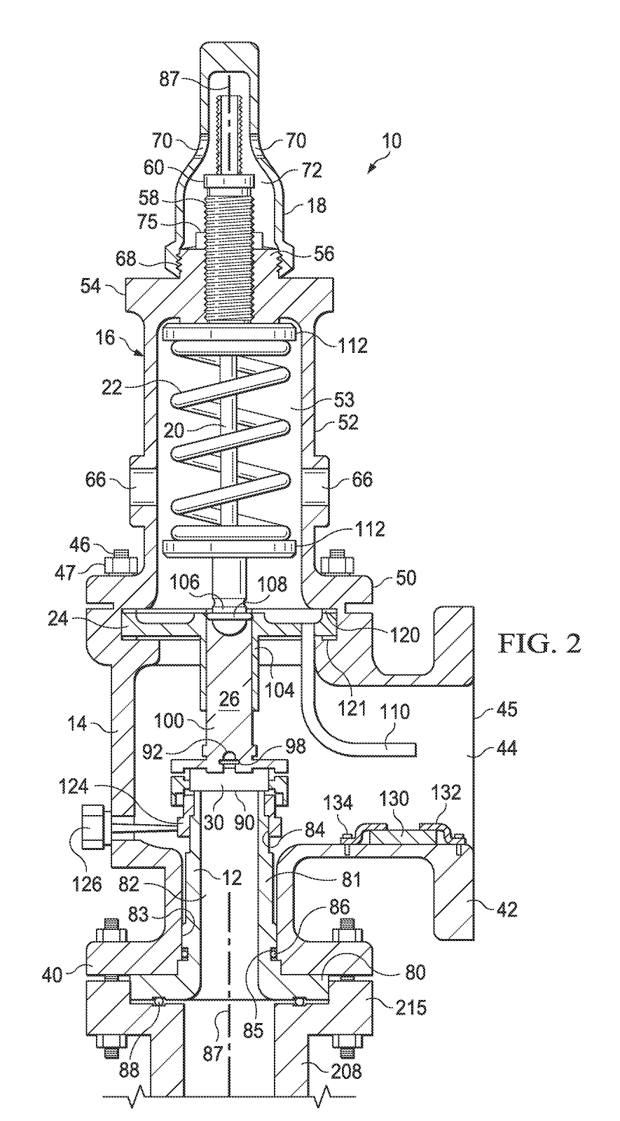

Referring now to FIG. 2, the pressure relief valve 10 generally includes nozzle 12, valve body 14, bonnet 16 and cap 18. Pressure relief valve 10 further includes spindle 20, coil spring 22, guide member 24, disk holder 26 and disk 30.

Valve body 14 includes base flange 40 for attaching pressure relief valve 10 to the distribution manifold 208, an outlet flange 42 suitable for connecting the valve body to another flow line or other vessel or container, and an interior base chamber 44. In this embodiment, flange 42 is left unconnected, such that chamber 44 is open to the ambient environment and thus is flooded with seawater that enters the chamber 44 at chamber outlet 45. The upper end of body 14 includes upwardly-extending studs 46 for attaching bonnet 16.

Bonnet 16 includes a base flange 50, a cylindrical wall 52 extending away from flange 50, and a top portion 54. Top portion 54 includes an extension 56 having external threads. A central threaded bore 58 extends through top 54 and extension 56 for receiving spring adjusting screw 60. Top portion 54 and cylindrical wall 52 define an interior chamber 53 within bonnet 16. One or more apertures or ports 66 are formed through cylindrical wall 52 to permit seawater to flood the bonnet chamber 53. Tube 110 extends between interior base chamber 44 through guide member 24 and opens into bonnet chamber 53, thereby placing bonnet chamber 53 in fluid communication with chamber 44.

Cap 18 includes an internally threaded segment 68 that threadably engages threaded extension 56 of the bonnet 16. Apertures or thru ports 70 are formed through the wall of cap 18 to allow seawater to flood the cap's interior chamber 72.

Nozzle 12 includes a lower base flange 80 and a tubular nozzle extension 81 extending along seal axis 87 and having interior 82 that is in fluid communication with the hydrocarbons in manifold 208. The outside surface of nozzle extension 81 includes two externally threaded segments 83 and 84, and a seal groove 85. Annular seal 86 is disposed in seal groove 85 and seals between the nozzle 12 and valve body 14. Threaded segment 83 threadably engages a correspondingly threaded segment on the inner surface of valve body 14. The upper end of nozzle 12 forms seal rim 90, which sealingly engages sealing disk 30 when the pressure of the hydrocarbons within the manifold 208 is below a predetermined value.

Disk 30 includes extension 92 on its upper end which is received in a mating recess in disk holder 26. Retaining ring 98 retains disk 30 on disk holder 26. The upwardly-extending portion 100 of disk holder 26 is slidably received in the sleeve 104 of guide 24. Spindle 20 includes a connecting end 106 that is retained in the upper end of disk holder 26 via retaining ring 108. Coil spring 22 is disposed about spindle 20 and retained between a pair of spring retainers 112 within bonnet chamber 53. Upper spring retainer 112 is fixed relative to adjusting screw 60 such that, as adjusting screw 60 is rotated to move it axially towards guide member 24, upper spring retainer 112 likewise moves axially downward. Lower spring retainer 112 is fixed relative to spindle 20 such that, as upper spring retainer 112 moves downward and compresses coil spring 22, force is exerted downwardly on disk holder 26 and disk 30, increasing the sealing force between disk 30 and nozzle rim 90.

The pressure brought to bear on the sealing surfaces of nozzle rim 90 and disk 30 is adjustable by means of adjusting screw 60. With cap 18 removed, adjusting screw 60 may be rotated in order to adjust the spring force supplied by spring 22 and thereby adjust the force applied to disk 30 so that disk 30 seals against seal rim 90 of nozzle 12. Locking nut 75 is disposed about adjusting screw 60 and employed to fix the axial position of adjusting screw 60 relative to bonnet 16 once the spring tension is appropriately adjusted. Once the appropriate spring force is applied and locking nut 75 tightened, cap 18 is threaded back over the top of bonnet 16. Nozzle rim 90, disk 30, extension 100 of disk holder 26, spindle 20 and adjusting screw 60 are, in the embodiment shown, all coaxially aligned with seal axis 87.

Studs 46 are connected to and extend upwardly from valve body 14 where they are received in aligned apertures circumferentially spaced about base flange 50 of bonnet 16. Retaining nuts 47 are disposed about the studs 46 to attach the bonnet 16 to the body 14. Gaskets 120, 121 are disposed between guide 24 and bonnet 16, and between guide 24 and valve body 14, respectively.

Blow-down adjusting ring 124 is disposed about threaded segment 84 on nozzle 12. Adjusting ring 124 is employed in order to adjust the size of the opening that is created after the disk 30 lifts off nozzle rim 90 upon the pressure in the manifold 208 reaching a predetermined maximum value, and thereby to adjust the pressure at which disk 30 will reseat on nozzle rim 90. Once ring 124 is appropriately adjusted, pin 126 fixes the ring's position and prevents adjusting ring 124 from moving axially along nozzle 12.

Components of valve 10 may be made of corrosion-resistant materials such as Super Duplex stainless steel. Alternatively, components may be made of carbon steel. Due to the corrosive nature of seawater, it is preferred that a measure of cathodic protection be applied to slow corrosion, particularly where carbon steel is employed. Accordingly, as shown in the embodiment of FIG. 2, an anode 130 is disposed within chamber 44 and placed in direct engagement with body 14. Anode 130, which may be made of a material such as zinc or aluminum, for example, is fastened to body 14 in this embodiment by straps 132 and threaded fasteners 134, although it may be attached to be in engagement with body 14 by other means. In this manner, a degree of cathodic protection is provided to all metal components that are coupled, directly or indirectly, to body 14. Such cathodic protection can be accomplished by attaching anode 130 to other metallic portions of pressure relief valve 10; however, attaching anode 130 within chamber 44 is convenient, and also places the anode in a position less-likely to be knocked loose and detached as the valve is transported and installed subsea.

Certain metals and alloys are detrimentally affected by the hydrogen atoms that are evolved when cathodic protection is provided. In particular, hard materials employed in certain high-strength bolts and springs are particularly susceptible to cracking when exposed to hydrogen ions. Accordingly, in the example described above, spring 22 is optionally made of a material that is less-susceptible to cracking in the presence of hydrogen ions.

Base flange 80 of nozzle 12 is placed in engagement with the manifold 208 and positioned such that nozzle chamber 82 is in fluid communication with pressurized fluid within the manifold 208. Base flange 40 of body 14 is then bolted to a corresponding flange 215 on the manifold 208. Seal 88 seals between flange 80 and manifold 208. In such position, the central chamber 82 of nozzle 12 will be filled with the hydrocarbons and pressurized to the same extent as the manifold 208. Given that bonnet 16 includes ports 66 and that outlet 45 of valve body 14 is open to receive sea water, both bonnet chamber 53 and base chamber 44 will be flooded with seawater. Likewise, cap 18 is flooded, the sea water entering into cap chamber 72 via ports 70. Consequently, the central chambers of cap 18, bonnet 16, and body 14 will all be flooded and will experience the same pressure, and the lift pressure required to unseat disk 30 from nozzle rim 90 will be unaffected by the pressure of the seawater.

Should the pressure in manifold 208 and in chamber 82 of nozzle 12 create a force that exceeds the force provided by the predetermined and preapplied pressure supplied by spring 22 on disk 30, disk 30 will be unseated from rim 90 of nozzle 12, such that the pressurized hydrocarbons will exit nozzle 12 and enter chamber 44 and be expelled through outlet 45 into the surrounding seawater. When the excessive pressure is relieved and the pressure within manifold 208 drops to a pressure level less than that which causes the seal members to disengage, the spring force will push the disk 30 back into sealing engagement with nozzle rim 90. At this point, the flow of hydrocarbons from manifold 208 into chamber 44 and the surrounding sea water is stopped.

By flooding bonnet chamber 53 and cap chamber 72, in addition to body chamber 44, with seawater, as described above, all components of the valve 10 are maintained at the same pressure. This permits the pressure relief function of valve 10 to operate subsea, even at tremendous pressures that exist.

While preferred embodiments have been shown and described, modifications thereof can be made by one skilled in the art without departing from the scope or teachings herein. The embodiments described herein are exemplary only, and are not limiting. Many variations and modifications of the disclosed apparatus are possible and are within the scope of the invention. Accordingly, the scope of protection is not limited to the embodiments described herein, but is only limited by the claims that follow, the scope of which shall include all equivalents of the subject matter of the claims.

What is claimed is:

1. A subsea pressure relief valve comprising:
a water-filled nozzle in fluid communication with a hydrocarbon distribution manifold;
a valve body connected to the distribution manifold, an outlet of the nozzle coincident with a first interior water-filled chamber of the valve body;
a first seal element removably seated against the nozzle outlet; and
a spring configured to sealingly seat the first seal element against the nozzle outlet until hydrocarbon pressure exceeds a sealing pressure of the spring and unseats the first seal element from the nozzle outlet such that excess hydrocarbons exit through an outlet of the valve body.

2. The valve according to claim 1, further comprising a second water-filled chamber housing the spring, wherein each of the water-filled components maintains a pressure balance over an entirety of the pressure relief valve.

3. The pressure relief valve of claim 2, wherein the water-filled chamber housing the spring includes at least one port allowing water to fill the chamber.

4. The pressure relief valve of claim 2, further comprising a water-filled tube extending between the second water-filled chamber housing the spring and the first interior water-filled chamber of the valve body.

5. The pressure relief valve of claim 1, wherein the water pressure in each of the chambers is equal to the water pressure of the water that surrounds the pressure relief valve.

6. The pressure relief valve of claim 2, wherein the first and second chambers are in fluid communication with each other and with a surrounding body of water.

7. The pressure relief valve of claim 2, wherein all chambers in the valve are adapted to be in fluid communication with a surrounding body of water.

8. The pressure relief valve of claim 1, further comprising:
an anode coupled to the valve body to provide cathodic protection to the valve.

9. The pressure relief valve of claim 8, wherein the anode is disposed in the first water-filled chamber of the valve body.

10. A pressure relief valve for protecting against overpressure conditions in a volume of hydrocarbons contained subsea, comprising:
a base portion comprising a base chamber, and a nozzle extending into the base chamber and in fluid communication with the volume of contained hydrocarbons, the base chamber having an outlet that is open to a surrounding body of water for porting into the body of water hydrocarbons that enter the base chamber through the nozzle;
a bonnet portion coupled to the base chamber and having a bonnet chamber that is in fluid communication with the base chamber and in fluid communication with the body of water;
a disk disposed in the base chamber and adapted to sealingly engage the nozzle and prevent the volume of contained hydrocarbons from entering the base chamber when the fluid pressure of the contained hydrocarbons is less than a predetermined pressure, and to disengage from sealing engagement with the nozzle when the fluid pressure of the contained hydrocarbons equals or exceeds the predetermined pressure; and
a spring housed in the bonnet chamber adapted to supply a force to bias the disk to sealingly engage the nozzle when the fluid pressure of the contained hydrocarbons is less than the predetermined pressure.

11. The pressure relief valve of claim 10, wherein the bonnet includes a wall separating the bonnet chamber from the surrounding body of water and at least one port formed in the wall, the port providing a passageway between the bonnet chamber and the surrounding body of water.

12. The pressure relief valve of claim 10, further comprising a tube in the base chamber that provides a passageway between the bonnet chamber and the base chamber.

13. The pressure relief valve of claim 10, further comprising a cap portion disposed on the bonnet portion and having a wall separating the cap interior from the surrounding body of water, and having at least one port formed in the cap wall, the port providing a passageway between the cap interior and the surrounding body of water.

14. The pressure relief valve of claim 9, further comprising an anode coupled to the base portion to provide cathodic protection to the valve.

15. The pressure relief valve of claim 14, wherein the anode is disposed inside the base chamber.

16. A subsea system for containing a volume of hydrocarbons, comprising:
a subsea container having hydrocarbons retained therein;
a pressure relief valve coupled to the subsea container and adapted to relieve pressure in the container if the pressure reaches a predetermined value, the relief valve comprising:
a plurality of water-filled chambers;
a metal to metal seal in one of the water-filled chambers;
a spring member in one of the water-filled chambers adapted to bias a first seal member into sealing engagement with a second seal member when the hydrocarbon pressure in the container is less than the predetermined value; and
an outlet to port into the body of water hydrocarbons that enter the valve when the hydrocarbon pressure in the container is greater than or equal to the predetermined value.

17. The subsea system of claim 16, further comprising at least one port between the water-filled chamber housing the spring member and the body of water.

18. The subsea system of claim 16, wherein the relief valve further comprises:
a base chamber that includes the outlet;
a bonnet portion coupled to the base chamber and having a bonnet chamber housing the spring member; and
a cap portion disposed on the bonnet portion and having a cap chamber;
wherein the bonnet chamber and cap chamber include ports connecting the cap chamber and bonnet chamber with the body of water.

19. The subsea system of claim 16, wherein the subsea container is a distribution manifold in fluid communication with the wellbore, the manifold receiving hydrocarbons flowing from the wellbore and through a BOP stack.

20. The subsea system of claim 18, further comprising an anode coupled to the base portion and retained inside the base chamber.
